(19) United States
(12) Patent Application Publication
(10) Pub. No.: US 2005/0164713 A1
(43) Pub. Date: Jul. 28, 2005

(54) Assisted location through the establishing of a cellular network mobile communication terminal USSD transport channel, for a call centre

(75) Inventor: Jacky Tang-Taye, Montfort L'Amaury (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/041,403

(22) Filed: Jan. 25, 2005

(30) Foreign Application Priority Data
Jan. 26, 2004 (FR) 04 50 133

(51) Int. Cl. H04Q 7/20

(52) U.S. Cl. 455/456.2; 455/456.1

(57) ABSTRACT

A communication system consists of a cellular communication network, a satellite positioning network coupled to an assistance data server, which itself coupled to the cellular network, and mobile communication terminals (T) coupled to the cellular network and comprising an satellite assisted positioning device (D) coupled to the positioning network and the server. The mobile terminals (T) also incorporate USSD type data management means (MGT), able to establish USSD type data transport channels, with the server, and processing means (PM) responsible, when they detect the dialing by one of the mobile terminals (T) of a selected call number designating a call center, for coupling the USSD type data management means (MGT) to the device (D), so that they establish a USSD type data transport channel between the device (D) and the server, such that the latter cooperates with the device (D) to obtain the position of the calling terminal (T). Furthermore, the call centre is responsible, if it judges it necessary to locate the calling terminal (T), for transmitting to the server a request asking it to provide the position of the calling terminal (T) once it has obtained it.

The invention relates to the field of cellular communication networks, and more specifically to the locating through satellites of mobile communication terminals attached to such networks, in the event of a call from a dedicated, and possibly emergency, number.

“Mobile terminal” is understood here to mean any communication terminal able to exchange data with a cellular network, such as a mobile phone, for example, a personal digital assistant (PDA) or a laptop computer equipped with a radio communication interface.

Some call numbers, such as emergency numbers, for example, allow users to establish communications with (emergency) call centers, such as security services or government departments, in order to inform them of a priority event. This is the case for the number 112 in Europe or 911 in the United States.

In some emergency situations, assistance must be given as quickly as possible at the site of the call. However, when an emergency communication is established, the caller may not have enough time to inform the emergency call center of his location owing to the situation, or because of the operating condition of his communication terminal, or the caller may omit to specify where he is located. In these situations, and if the emergency call center called considers it necessary, a calling terminal location procedure must be implemented.

At least two types of location procedures have been proposed. A first type consists of determining the identifier of the cellular network cell in which the calling terminal is located. This first type of procedure is particularly simple, but its preciseness depends on the cell in which the calling terminal is located. This preciseness may be slightly improved through measurements carried out by the terminal within the network and transmitted to the latter.

A second type consists of using specific network measurements, such as EOTD (for “Enhanced Observed Time Difference”) measurements, carried out by the calling terminal. The implementation of this type of procedure requires costly network adaptations, which do not sufficiently improve the preciseness of the location.

Furthermore, the network does not always permit the (quasi)simultaneous transmitting of audio communication data and data representative of specific measurements issuing from the calling terminal. This is particularly the case for GSM or GSM/GPRS type networks.

As no known procedure is completely satisfactory, the invention's aim is therefore to improve the situation.

To this end, it proposes a procedure for the location of mobile communication terminals attached to a cellular communication network, with each terminal including an satellite assisted positioning device, able to be coupled to a satellite positioning network, which is itself coupled to an assistance data server.

“Satellite assisted positioning device” is understood here to mean a device able to determine the position (or data useful for location) of the mobile terminal in which it is located from navigation data provided by an RNSS (for “Radio Navigation Satellite Service”) satellite positioning network, such as, for example, the GPS network, the GLONASS network, or the future GALILEO network, and from assistance data provided by an assistance data server coupled to the RNSS network to the cellular network to which the mobile terminal is attached.

The location procedure according to the invention is characterized in that it consists, when one of the mobile terminals internally detects the dialing of a selected call number designating a call center, of establishing a USSD type data transport channel, between the terminal's positioning device and the assistance data server, such that the latter cooperates with the positioning device in order to obtain the position of the calling terminal and, if the call center called detects that it is necessary to locate the calling terminal, of requesting that the server transmits the position once it has obtained it.

Two situations may be envisaged once the USSD transport channel has been established:
Either the calling terminal transmits data representative of the identifier of the cell in which it is located to the server, such that it determines from these data assistance data representative of the identifiers of at least three satellites visible in the cell in which the calling terminal is located, then transmits to the calling terminal, via the USSD transport channel, data representative of the identifiers determined,
Or the server determines, within the cellular network, data representative of the identifier of the cell in which the calling terminal is located, in order to determine from these data, assistance data representative of the identifiers of at least three satellites visible in the cell in which the calling terminal is located, then it transmits, via the USSD transport channel, data representative of the identifiers determined, to the calling terminal.

In either case, when the device receives the assistance data, it determines either the position of the terminal in which it is located in order to transmit it to the server, automatically or at its request, or the distances that separate its terminal from each of the satellites identified, in order to transmit to the server, automatically or at its request, via the USSD transport channel, data representative of the terminal/satellite distances determined, then the position of the calling terminal is determined at server level.

Preferably, if the server receives the location request before obtaining the position, it waits for this required position before transmitting it to the call center. However, if the server receives the location request after obtaining the position, it immediately transmits it to the center.

Furthermore, the data transmissions in the USSD transport channel take place, for example, in the form of end-to-end dedicated messages and according to a user plane protocol.

The invention is particularly well suited, although not exclusively, to 2G cellular communication networks, such as GSM networks.

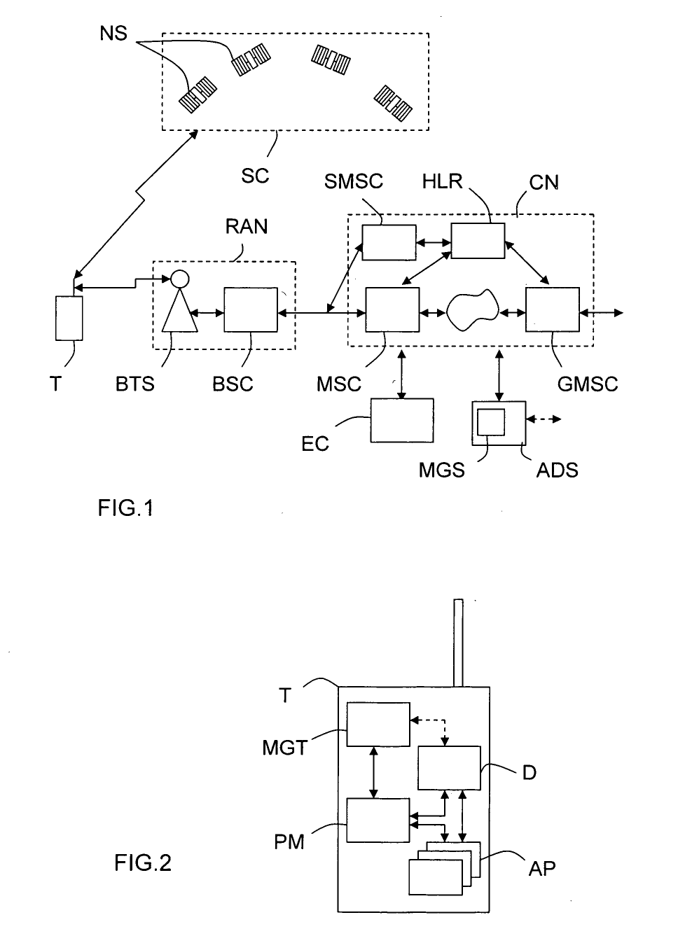

Other characteristics and advantages of the invention can be found on examining the detailed description below and the drawings appended, on which:
FIG. 1 illustrates in diagrammatic form an example of a GSM network coupled to an emergency call center and the assistance data server of an assisted satellite positioning system, and
FIG. 2 illustrates in diagrammatic and functional form an example of a mobile terminal according to the invention.

The drawings appended may not only complement the invention, but also contribute to its definition, should the case arise.

The purpose of the invention is to allow the location of mobile communication terminals, attached to cellular networks, when such terminals dial dedicated, possibly emergency, call numbers.

“Mobile terminal” is understood here to mean any type of mobile terminal able to exchange data with a cellular communication network. This might therefore include, for example, a mobile telephone, a personal digital assistant (or PDA) or a laptop computer equipped with a radio communication interface. In the following, mobile terminals are taken to be mobile telephones, by way of an illustrative example.

Furthermore, as illustrated in FIG. 1, in the following, the cellular communication network to which the mobile terminals T are attached is taken to be a GSM network, by way of a non-limitative example. Of course, the invention is applicable to any other type of cellular network, and particularly GSM/GPRS and UMTS networks (and all their equivalents).

The GSM network illustrated, to which the mobile telephones T are attached, is of the most traditional type. It may be summed up, as illustrated in FIG. 1, as a radio access network, known as a BSS, and coupled by an interface (known as A) to a Core Network, or CN (or NSS), which may itself be coupled to one or several other public and/or private networks.

The CN core network (or NSS) consists first of all of a Mobile Switching Center, or MSC, coupled to interface A and responsible for carrying out the operations necessary for the management of communications in circuit mode with the mobile terminals T attached to its network. This MSC mobile switching center may possibly be coupled to one or several other fixed or mobile networks by means of a Gateway MSC, or GMSC. The CN core network also includes a message switching center known as an SMSC (for “Short Message Switching Center”), coupled with interface A and responsible for carrying out the operations necessary for the management of messages, in particular SMS type messages, with the mobile terminals T attached to its network. The CN core network also includes a database known as the HLR (for “Home Location Register”), containing both static and dynamic information about the mobile terminals T (last known location or position of the last cell in which the terminals were located). The MSC, SMSC and GMSC are all coupled to the HLR in order to obtain the information about the mobile terminals that is necessary for their respective processing.

The BSS radio access network usually consists both of several radio network nodes or controllers, known as BSCs (for “Base Station Controllers”), coupled to the CN core network via interface A, and several transmission/reception base stations, known as BTSs, each associated with one or several cells each covering a radio zone, and coupled alone or in groups of at least two to one of the BSCs via a logic interface known as an Abis.

According to the invention, an ADS assistance data server is also required, coupled directly or indirectly to the CN core network of the GSM network and to an SC satellite positioning network.

“Satellite positioning network” is understood here to mean an RNSS (for “Radio Navigation Satellite System”) network comprising an SC constellation of NS navigation satellites, such as, for example, the GPS network, the GLONASS network, the future GALILEO network, or a combination of at least two of the three networks referred to above. An SC network of this kind is designed to provide mobile terminals T equipped with a satellite positioning device (or receiver) with the navigation data allowing them to determine their position, or parameters useful in determining their position, and particularly the distances that separate them from “visible” NS navigation satellites.

To allow the implementation of the invention, and as illustrated in FIG. 2, the mobile telephones T are equipped with an assisted type satellite positioning device D that may be coupled not only to the SC satellite positioning network, but also to the ADS assistance data server, in order to be supplied with assistance data facilitating location or the determination of parameters useful for location.

In the following, by way of example, the SC satellite positioning network and ADS assistance data server are considered to constitute an assisted satellite positioning system of the A-GPS (or “Assisted-GPS”) type.

As the assisted satellite positioning system (GPS network (SC reference in FIG. 1) and A-GPS assistance data server (ADS)) and its overall operation are completely traditional in nature, they will not be described in any more detail. The respective operating of the GPS network (SC) and the associated A-GPS assistance data server (ADS) therefore remain unchanged in relation to previous practice. It should simply be remembered that the A-GPS server (ADS) is responsible for delivering, on request, assistance data representative in particular of the identifiers of the NS navigation satellites that are visible in the cell in which the mobile terminal that is the object of the request is located, from the estimated position of this cell, deduced from its cell identifier (provided by the GSM network or by the mobile terminal T) and the current positions of the GPS network's NS navigation satellites.

Further information about the A-GPS network may be found on the 3GPP website and more specifically in appendix D to the 3GPP document “Location Services (LCS); Functional Description Stage 2” where it is referenced as 3GPP TS 03.71 V8.2.0.

The SC satellite positioning network, the A-GPS ADS assistance data server and the cellular network (GSM) together form a communication system.

The invention proposes a mobile telephone T location procedure consisting, each time that one of the mobile telephones T internally detects the dialing of a selected call number (an emergency number, for example), designating an EC call center (an emergency call center, for example), of establishing a USSD (for “Unstructured Supplementary Service Data”) data transport channel, between its positioning device D and the A-GPS ADS assistance data server, so that the latter cooperates with positioning device D to obtain the position of calling mobile telephone T, and, if the (emergency) call center known as the EC detects that it is necessary to locate the calling mobile telephone T, of asking the A-GPS ADS server to transmit the position to the EC (emergency) call center once it has obtained it.

“Obtain” is understood here as both receiving from mobile telephone T, via the USSD transport channel, data representative of its position, and internally determining the position of the mobile telephone T from data representative of the telephone/satellite distances that it has transmitted via the USSD transport channel.

Detailed information about the formalism of the USSD channels and the means necessary for their implementation may be found on the 3GPP website, and more specifically in the specifications 3GPP TS 22.090 (“Unstructured Supplementary Service Data (USSD)”—Stage 1), 3GPP TS 23.090 version 4.0.0 Release 4 (“Unstructured Supplementary Service Data (USSD)”—Stage 2), and 3GPP TS 24.090 version 4.0.0 Release 4 (“Unstructured Supplementary Service Data (USSD)”—Stage 3).

For the invention to be implemented, it is vital, as illustrated in FIGS. 1 and 2, that the A-GPS ADS assistance data server and the mobile telephone T are each equipped with a USSD type data management module (MGS, MGT), in order to cooperate with the establishing, on request, of a USSD transport channel, through the exchanging of signaling according to a “proprietary” protocol, such as, for example, the so-called “User Plane Protocol”.

Such a channel is intended to allow device D and the A-GPS ADS server to exchange data in the form of end-to-end dedicated messages according to the user plane protocol. These USSD dedicated messages offer the advantage of being independent of any audio type communication established between the mobile telephone T concerned and the EC (emergency) call center. They are made up of a string of bytes, usually a maximum of 160 bytes, allowing the transferring of characters, and usually a maximum of 182 (as described in specification 3GPP TS 23.038 version 4.4.0 Release 4, “Alphabets and language-specific information”).

In the following, the EC call center is considered to be an emergency call center.

Each mobile telephone T according to the invention has a PM processing module responsible for analyzing the telephone numbers (or communication identifiers) that it uses to establish communications with other communication terminals. More specifically, each PM processing module has a list of at least one selected call number, known as the emergency call number that designates an emergency call center. Examples of such numbers are 112 in Europe or 911 in the United States.

If a telephone number is dialed within a calling mobile telephone T, its PM processing module compares the number with the number(s) in the list, and if the number is identified it puts the MGT management module and device D of its calling mobile telephone T in communication so that said MGT management module can establish a “link” with the device D, which is necessary for establishing a USSD transport channel between device D and the A-GPS ADS server.

The MGT management module then initiates with the CN core network the establishing of a USSD transport channel between the device D and the A-GPS ADS server. The CN core network then informs the MGS management module of the A-GPS ADS server that a USSD transport channel must be established between said A-GPS ADS server and the device D of the calling mobile telephone T. The MGT and MGS management modules then traditionally exchange signaling messages in order to establish the USSD transport channel.

Once the USSD transport channel has been established between a device D and the A-GPS ADS server, the device D asks the A-GPS ADS server, via this channel, for the assistance data representative of the NS satellite identifiers that are visible within the cell in which its mobile telephone T is located.

For these assistance data to be transmitted, the A-GPS ADS server must, however, have the identifier of the cell in which the calling mobile telephone T is located. This identifier may be provided either by the mobile telephone T or by the GSM network.

In the first case, the PM processing module of the calling mobile telephone T internally determines the cell's identifier, includes it in a location request that it transmits to the MGT management module so that it transmits it to the MGS management module of the A-GPS ADS server, via the USSD transport channel.

This transmitting of data representative of the cell's identifier takes place in the USSD transport channel in the form of end-to-end dedicated messages and according to the proprietary user plane protocol.

On receipt of the cell's identifier, the A-GPS ADS server determines the corresponding position of the cell in an identifier/position database that is regularly updated by the cellular network.

In the second case, when the A-GPS ADS server receives from the device D of the calling mobile telephone T its request for assistance data, it immediately determines from the GSM network, and more specifically from the HLR, the identifier of the cell in which said calling mobile telephone T is located. Once in possession of this identifier, it uses it to deduce the position of the cell by interrogating the identifier/position database.

In either case, the A-GPS ADS server determines in a traditional way the identifiers of the NS satellites visible in the cell whose position it has just determined from the identifier received. To do this it uses the current positions of the GPS network SC constellation's NS satellites, which it recovers using one of the reference receivers providing real time information about the NS satellites.

Once the identifiers have been determined, the A-GPS ADS server generates data that represent them and transmits them to the device D, via the USSD transport channel. This transmission, like any other transmission occurring between the device D and the A-GPS ADS server also takes place in the form of a dedicated USSD message, according to the user plane protocol.

When the device D receives the identifiers of the NS satellites visible in the cell where its mobile telephone T is located, it has only to align itself in the traditional way to estimate the distances that separate it from four of them (and a minimum of three). As professionals in this field know, this alignment process is a lot faster than in the non-assisted case.

Usually, if the mobile telephone T incorporates an internal AP application requiring its position at selected times, its assisted positioning device D is set up to determine each position itself from the telephone/satellite distances that it has estimated. In this case the device D operates in so-called “MS-based” mode. In such a scenario, once the device D has estimated the telephone/satellite distances, it determines the position of the telephone T from said telephone/satellite distances.

However, the device D may only be set up to estimate the telephone/satellite distances. In this case it is operating in so-called “MS-assisted” mode. In such a scenario, once it has estimated the telephone/satellite distances, it transmits them to the A-GPS ADS server so that it can determine the position of the calling mobile telephone T.

As indicated previously, in the procedure according to the invention two processes take place at the same time: the obtaining by the A-GPS ADS server of the position of the calling mobile telephone T (described above) and the determining by the emergency call center known as EC of the usefulness of obtaining the calling mobile telephone T's position.

When the EC emergency call center receives the emergency call from the calling mobile telephone T, a telephone conversation is initiated between the user of the telephone T and an EC emergency call center operator. The operator must then judge whether the situation requires the obtaining of the position of the calling mobile telephone T. As a variant or addition, the EC emergency call center may be set up to automatically decide the usefulness of obtaining the position of the calling mobile telephone T, for example, according to the call number used and/or an identification code transmitted (the EC center may possibly manage calls intended for several departments or government bodies). In either case, once it has judged that the position of the mobile telephone T needs to be obtained, the EC emergency call center generates a request destined for the A-GPS ADS server, asking it to transmit said position. This request is transmitted via the GSM network.

Two scenarios must therefore be envisaged.

In the first scenario, the A-GPS ADS server does not yet have the position of the calling mobile T when it receives the request transmitted by the EC emergency call center. In this case, the A-GPS ADS server waits until it has obtained the required position before transmitting it to the EC emergency call center, via the GSM network.

To obtain the position of the telephone T, the A-GPS ADS server may transmit a request to said telephone T, possibly accompanied by assistance data, via the USSD channel, on receipt of the request issuing from the EC emergency call center. Depending on whether the device D operates in MS-assisted or MS-based mode, it transmits to the A-GPS ADS server, in response to its request, either the telephone/satellite distances that it has determined, or the position of the telephone T that it has determined. If the A-GPS ADS server receives data representative of the telephone/satellite distances, it then determines the position of the telephone T. As a variant, the device D might automatically transmit to the A-GPS ADS server data representative of the telephone/satellite distances or of the position of telephone T once it has received assistance data within the context of the emergency call number's use.

In a second scenario, the A-GPS ADS server already has the position of the calling mobile T when it receives the request transmitted by the EC emergency call center. This situation can only occur in the case described above where the device D automatically transmits to the A-GPS ADS server the telephone/satellite distances or the position of the telephone T that it has determined. In this case, the A-GPS ADS server immediately transmits the required position to the EC emergency call center, via the GSM network, in response to the request issuing from the EC emergency call center.

Preferably, if the EC emergency call center judges that it is not useful to determine the position of the calling mobile telephone T, it does not send a request to the A-GPS ADS server. In this case, either the A-GPS ADS server already has the position of the telephone T and it has automatically destroyed it once a selected period has elapsed, or it doesn't have its position and in this case nothing happens.

Once a position has been determined and transmitted to the EC emergency call center, or determined then destroyed, the corresponding USSD transport channel is also destroyed.

Assistance data other than the identifiers of visible satellites may be transmitted by the A-GPS ADS server to a device D, either spontaneously, or at the request of the device D, if they may be useful in determining the telephone/satellite distances and/or the position of the telephone hosting the device D.

The PM processing module, the MGT and MGS USSD management modules and the satellite assisted positioning device D, may be created in the form of electric circuits, software (or computer) modules, or a combination or circuits and software.

The invention is particularly advantageous in that it may be implemented without modifications to the cellular networks, and in particular their architectures and protocol.

Furthermore, the invention is not limited to the communication system, mobile communication terminal, assistance data server and location procedure applications described above, only by way of example. It covers all the variants that may be envisaged by professionals in the field within the context of the claims below.

In the above, a communication system comprising a single (emergency) call center has been described; however, the system may include several call centers if they are all coupled, directly or indirectly, to the assistance data server.

Furthermore, in the above, an application of the invention to the location of emergency calls has been described; however, the invention also applies to location on request if a dedicated call number is used. Indeed a specific number may be dedicated either through navigation, for example in a situation where the user of the calling terminal is lost in an unknown place or stuck in a traffic jam. In this case, the obtaining of the calling terminal's position may, for example, allow an application, external to the assistance data server and associated with the specific call number, to guide the user so that he can find his way or get out of a traffic jam. For this to be possible, a USSD request must be triggered from the mobile terminal following the detecting of the specific number dialed, allowing the triggering of the location procedure via a USSD channel created for this purpose. The location is then provided on request to the application called requesting it from the assistance data server.

1. A procedure for the location of mobile communication terminals (T) attached to a cellular communication network and each comprising an satellite assisted positioning device (D), suitable for being coupled to a satellite positioning network (SC) coupled to an assistance data server (ADS), characterized in that it comprises, if the dialing by one of said mobile terminals (T) of a selected call number designating a call center is detected, establishing a USSD type data transport channel, between the device (D) of said terminal and said server (ADS), such that said server cooperates with said device (D) to obtain the position of said calling terminal, and if said center called detects the need to locate said calling terminal, asking said server to transmit said position as soon as it has obtained it.

2. A procedure according to claim 1, characterized in that once said USSD transport channel has been established, said calling terminal (T) transmits to said server (ADS), via this USSD transport channel, data representative of the identifier of the cell in which it is located, such that it determines from these data assistance data representative of the identifiers of at least three satellites (NS) visible in the cell in which the calling terminal (T) is located, then transmits to said calling terminal (T), via said USSD transport channel, data representative of said identifiers.

3. A procedure according to claim 1, characterized in that once said USSD transport channel has been established, said server (ADS) determines within said cellular network data representative of the identifier of the cell in which the calling terminal (T) is located, in order to determine from these data assistance data representative of the identifiers of at least three satellites (NS) visible in the cell in which the calling terminal (T) is located, then said server (ADS) transmits to said calling terminal (T), via USSD transport channel, data representative of said identifiers.

4. A procedure according to one of the claims 2 and 3, characterized in that on receipt of said assistance data said device (D) determines the position of the terminal (T) in which it is located so as to transmit it to said server (ADS).

5. A procedure according to claim 2, characterized in that on receipt of said assistance data said device (D) determines the distances that separate the terminal (T) in which it is located from each of the satellites (NS) identified, so as to transmit to said server (ADS), via said USSD transport channel, data representative of said distances determined, then the position of said terminal (T) is determined at the level of said server (ADS).

6. A procedure according to claim 4, characterized in that said position or distance determined data are automatically transmitted to said server (ADS).

7. A procedure according to claim 4, characterized in that said position or distance determined data are transmitted to said server (ADS) at its request.

8. A procedure according to claim 1, characterized in that if said location request is received before said position has been obtained, the server (ADS) waits for said position before transmitting it to said center.

9. A procedure according to claim 1, characterized in that if said location request is received after said position has been obtained, the server (ADS) immediately transmits said position to said center.

10. A procedure according to claim 1, characterized in that said data transmissions in the USSD transport channel take place in the form of end-to-end dedicated messages according to a so-called user plane protocol.

11. A communication system comprising a cellular communication network, a satellite positioning network (SC) coupled to an assistance data server (ADS), coupled to said cellular network, and mobile communication terminals (T) coupled to said cellular network and comprising an satellite assisted positioning device (D) suitable for being coupled to said positioning network (SC) and to said server (ADS), characterized in that said terminals incorporate USSD type data management means (MGT) suitable for establishing USSD type data transport channels with said server (ADS) and adapted processing means (PM), if the dialing by their mobile terminal (T) of a selected call number designating a call center is detected, for coupling said USSD type data management means (MGT) to said device (D), so that they can establish a USDD type data transport channel between the device (D) and said server (ADS) such that said server cooperates with said device (D) to obtain the position of said calling terminal (T), and by the fact that said call center (EC) is set up, if the need to locate said calling terminal is detected (T), to transmit to said server (ADS) a request asking it to transmit the position of the calling terminal (T) once it has obtained it.

12. A system according to claim 11, characterized in that said calling terminal (T) processing means (PM) are set up, once said USSD transport channel has been established, to transmit to said server (ADS), via this USSD transport channel, data representative of the identifier of the cell in which it is located, and by the fact that said server (ADS) is set up, on receipt of said cell identifier, to determine assistance data representative of the identifiers of at least three satellites (NS) visible in the cell in which the calling terminal (T) is located, then to transmit to said calling terminal (T), via said USSD transport channel, data representative of said identifiers.

13. A system according to claim 11, characterized in that said server (ADS) is set up, once said USSD transport channel has been established, to determine within said cellular network data representative of the identifier of the cell in which the calling terminal (T) is located, in order to determine from these data assistance data representative of the identifiers of at least three satellites (NS) visible in the cell in which the calling terminal (T) is located, then to transmit to said calling terminal (T), via said USSD transport channel, data representative of said identifiers.

14. A system according to claim 12, characterized in that said device (D) is set up, on receipt of said assistance data, to determine the position of the terminal (T) in which it is located in order to transmit it to said server (ADS).

15. A system according to claim 12, characterized in that said device (D) is set up, on receipt of said assistance data, to determine the distances that separate the terminal (T) in which it is located from each of the satellites (NS) identified, in order to transmit to said (ADS), via said USSD transport channel, data representative of said distances determined, and by the fact that said server (ADS) is set up, on receipt of said distances, to determine the position of said terminal (T).

16. A system according to claim 14, characterized in that said device (D) is set up to automatically transmit to said server (ADS) said position or distance determined data.

17. A system according to claim 14, characterized in that said device (D) is set up to transmit to said server (ADS) said position or distance determined data, at its request.
